(19) United States
(12) Patent Application Publication
(10) Pub. No.: US 2003/0153287 A1
(43) Pub. Date: Aug. 14, 2003

(54) Method and apparatus for sensing operating temperature in a power amplifier

(76) Inventor: Tapio Kuiri, Oulu (FI)

Correspondence Address: PERMAN & GREEN, 425 POST ROAD, FAIRFIELD, CT, 06824, US

(21) Appl. No.: 10/075,503

(22) Filed: Feb. 14, 2002

(51) Int. Cl. H04B 1/04

(52) U.S. Cl. 455/127; 455/343

(57) ABSTRACT

A method and apparatus for sensing the operational temperature of a power amplifier within a mobile telephone is disclosed. A sensor circuit is connected to sense the voltage at the input of the bias current supply to the power amplifier. This voltage being indicative of the voltage drop over the biased transistor of the power amplifier will also be indicative of the operating temperature of the power amplifier.

### BACKGROUND OF THE INVENTION

In a wireless communication system, a radio communication channel extends between a sending station and a receiving station. A cellular communication system is a multi-user communication system in which several fixed-site base stations operate to communicate with radio telephones in a geographical area. The communication signals are transmitted with controlled power between a base station and a radio telephone. Each of the radio telephones, therefore, must be equipped with appropriate power control systems.

A power control system for a radio telephone is described in U.S. Pat. No. 6,178,313, which is commonly owned with the subject application. The disclosure of the '313 patent is incorporated herein by reference. Such a system is used to ensure that transmitted communication signals are strong enough to recover the informational content at the receiver, but also low enough to not reduce the communication capacity of the communication channel. The communications system of the '313 patent utilizes a closed-loop power control scheme in which power control signals are generated and transmitted by network infrastructure on the forward link channel to a radio telephone. These power control signals control the power levels for the reverse link communication signals transmitted by the radio telephone.

The transmitter portion of a radio telephone, therefore, typically includes a power amplifier. The power amplifier amplifies a reverse link signal prior to its transmission so that it will be received by a base station via a radio channel. A power amplifier requires relatively large amounts of energy for its operation. Conventionally, power amplifiers are powered or biased to optimize the the transmitter efficiency on the different power levels transmitted by the radio telephone. However, the typical power levels of reverse link signals are generally significantly less than the maximum power levels.

It is well known that the performance of a power amplifier within a mobile telephone may be effected by the ambient temperature of the integrated circuit chip in which the amplifier is imbedded. In addition the power amplifier itself will generate heat during its operation which will have a significant effect on its operating temperature of its components. It would be advantageous, therefore, to monitor the temperature in order to compensate by adjusting signal or power levels or by shutting down the mobile telephone. It is a feature of this invention to provide a simple system for sensing the operational temperature of a power amplifier.

A power amplifier requires a bias current to maintain the power amplifier within its operational range. There is normally a voltage drop over a biased transistor and this voltage drop varies with the operational temperature of the transistor.

Although in many instances the bias circuit is contained in an integrated circuit (IC) chip of the power amplifier, this is restrictive, if a more intelligent adjustment of the bias is desired. Since it is prevalent to use Gallium Arsenide transistors in power amplifier ICs, intelligent biasing is difficult to achieve within the power amplifier IC. An intelligent bias circuit allows the adjustment of the bias to accommodate, varying output levels, temperature compensation, or power control. In such instances an external bias circuit will be used to adjust the bias circuit according to a predetermined algorithm. It is a feature of this invention to use the external bias circuit to monitor the operational temperature of the power amplifier.

It is a feature of this invention to sense the voltage drop over a component or components in the bias circuit to obtain a signal relative to the operating temperature of the power amplifier. Another feature of this invention is to monitor the operational temperature of the power amplifier using the external bias pin of the power amplifier IC.

### SUMMARY OF THE INVENTION

In accordance with the illustrated embodiment, the power amplifier of a mobile telephone transceiver circuitry is “intelligently” controlled via an external bias circuit. The external bias is provided to the power amplifier through a dedicated pin in the power amplifier IC. The biasing input is monitored to obtain a signal indicative of the voltage drop across the transistors of the amplifier. This signal is used directly to monitor the operating temperature of the power amplifier and generate signals for further use.

The RF signals processed by the radio telephone will have an effect on the bias current, in order to avoid inaccuracies that may be caused by this effect, it may be advantageous to time the temperature sensing sequence immediately after the transmission slot ends.

The monitoring circuit sequence is controlled by an algorithm. According to the monitoring sequence, the voltage at the bias input pin of the power amplifier integrated circuit (IC) is checked, indicating the voltage drop across the transistors within the power amplifier. In one embodiment of this invention, the checking is accomplished immediately following the end of an RF signal transmission. Since this voltage varies according to temperature, it is used to indicate the operating temperature of the IC. This information can be used within the control algorithm of a intelligent bias circuit to adjust the bias of the power amplifier as function of temperature, to adjust the gain control as a function of temperature, to shut down the power amplifier at excessive temperatures and other purposes.

### DESCRIPTION OF THE DRAWING

The subject invention is described in more detail below with reference to the drawing in which:

FIG. 1 is a block diagram of a mobile telephone transceiver;

FIG. 2 is a circuit diagram of a sensing circuit of this invention;

FIG. 3 is a block diagram of the steps of the method of the subject invention.

### DETAILED DESCRIPTION OF THE INVENTION

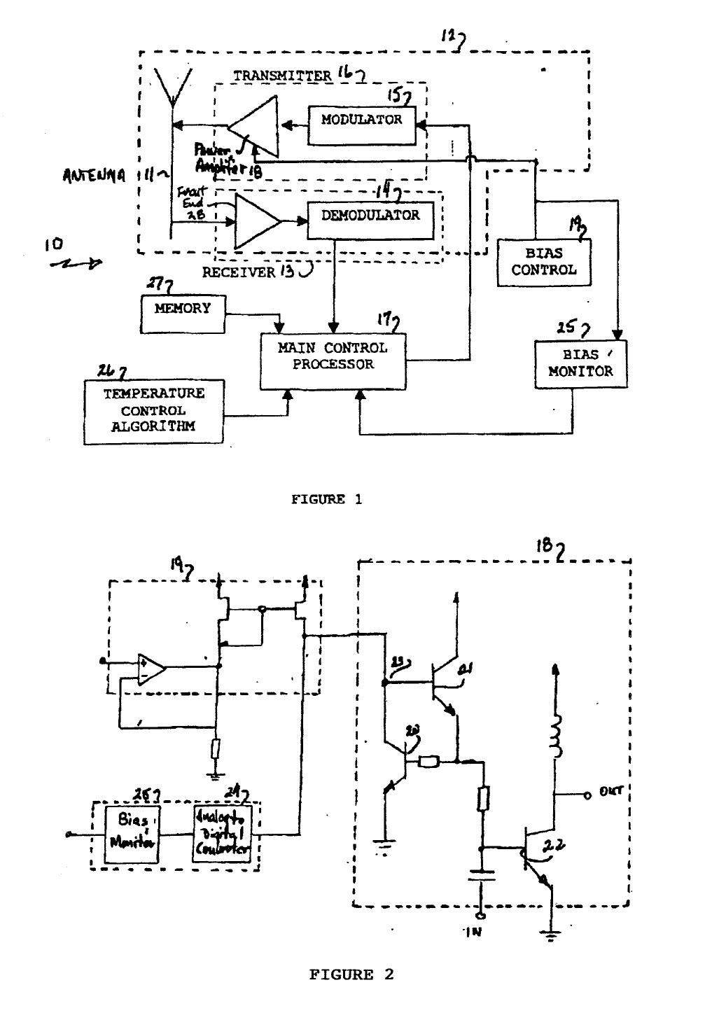

A mobile station 10 in which the temperature monitoring system of this application is operable, is shown in FIG. 1. In a conventional manner, the mobile station 10 is selectively tuned to receive signals through antenna 11 transmitted upon a forward channel from a base station (not shown).

The mobile station 10 includes a transceiver 12 which, in a well know manner, consists of a receiver 13 and transmitter 16. Transmitter 16 includes power amplifier 18 and modulator 15. Receiver 13 includes front end 28 and demodulator 14. The signal received at the receiver 13 is processed in the main control processor 17. A transmission signal is amplified in power amplifier 18 which forms part of transmitter 16.

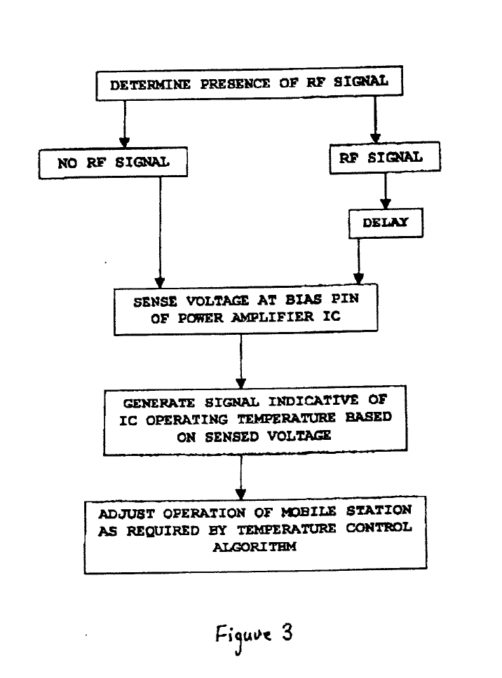

Power amplifier 18 has an external bias current supplied by bias control 19. A bias control system is shown, for example, in the '313 patent cited herein. Another, more simple, bias control is shown in FIG. 2. The power amplifier 18 is generally constructed of a set of transistors, for example transistors 20, 21, and 22 of the circuit of FIG. 2. Such power amplifiers are generally produced as an integrated circuit (IC) and provided with appropriate input pins for connection to associated modules. In circumstances, such as shown in the cited '313 patent, the bias circuit is controlled by an algorithm which varies the bias current according to predetermined parameters, such as data imbedded in the received signal. This so called “intelligent” bias is generally implemented in a circuit external to the power amplifier IC 18. A pin 23 is, therefore, constructed in the IC 18 to receive the external bias.

Depending on the type of transistors used, the power amplifier 18 will have a characteristic response to variations in temperature. In particular the voltage occurring across the transistor will vary with temperature in a known manner. Since the operating temperature of the IC 18, can significantly effect the performance of the mobile station 10, it is advantageous to monitor this temperature. The operating temperature is monitored by sensing the voltage at the pin 23. This voltage is representative of the voltage drop across the transistors and therefore may be used as a direct indication of the operating temperature of the IC.

In operation, as shown in FIG. 3, in the system of this invention, the signal at pin 23 is sensed and converted to a digital signal in converter 24 and directed to voltage/bias monitor 25 for processing. Bias monitor 25 is shown in FIG. 2 as a separate module, but could equally be implemented as a part of the main control processor 17. In either instance the monitoring function is controlled by a temperature control algorithm 26 which can be stored in the memory 27 of the mobile station 10. The temperature control algorithm 26 is constructed to cause the bias monitor 25 to generate a signal indicative of the operating temperature of IC 18. The algorithm 26 may be further designed to cause the main processor to shut down when excessive temperatures are reached or to adjust the bias in response to predetermined fluctuations in the temperature.

The bias current will also be effected by the RF signal being processed in the power amplifier. This could cause inaccuracies in the sensing of the temperature in IC 18. To avoid this problem, as indicated in FIG. 3, the algorithm 26 causes the bias monitor 25 to sense the voltage at pin 23 in a timed sequence immediately after the RF traffic slot.

In operation the power amplifier IC temperature is sensed by monitoring the voltage at the external bias pin 23 of the power amplifer IC 18. The sensed bias pin voltage provides a signal that is directly usable to monitor the the operating temperature of the IC 18. The temperature signal may be used to control the bias current, to provide warnings to the user, or to shut down the radio telephone. The sensing sequence is timed to avoid the effects of RF signals on the bias pin voltage.

By the use of the bias pin voltage as a temperature indicator, the use of an additional element, such as a temperature sensitive resistor, or the need for an additional connector pin on the IC is avoided. In addition the temperature that is sensed is at the critical location and not remote from the transistors as in the case of a separate element. The sensed temperature is therefore provided accurately in a cost effective manner without adding appreciably to the cost of the ASIC in which the power amplifier is imbedded.

The embodiments of FIGS. 1-3 are provided for illustration of possible implementations of the invention. It should be noted that the apparatus and method of this invention may be executed in a wide variety of power amplifiers, transistors and bias current sensing circuits which would be known to an artisan skilled in the art.

I claim:

1. A sensor system for obtaining the operating temperature of a power amplifier of a radio telephone, said power amplifier having at least one transistor, said sensor system comprising:
a bias supply circuit connected to the power amplifier for supplying a bias current to said power amplifier;
a monitor connected to the power amplifier at the input of the bias supply circuit for sensing a voltage indicative of the voltage drop across said transistor; and
a processor for generating a signal indicative of the operating temperature of said power amplifier in response to the sensed voltage.

2. A sensor system for obtaining the operating temperature of a power amplifier of a radio telephone, said power amplifier having at least one transistor, according to claim 1, wherein a temperature control algorithm causes said processor to adjust the operation of said radio telephone in response to said operating temperature signal.

3. A sensor system for obtaining the operating temperature of a power amplifier of a radio telephone, said power amplifier having at least one transistor, according to claim 2, wherein the temperature control algorithm causes the processor to shut off the radio telephone when the operating temperature signal exceeds a predetermined value.

4. A sensor system for obtaining the operating temperature of a power amplifier of a radio telephone, said power amplifier having at least one transistor, according to claim 2, wherein the temperature control algorithm causes the processor to adjust the bias control supply to the power amplifier in response to said operating temperature signal.

5. A sensor system for obtaining the operating temperature of a power amplifier of a radio telephone, said power amplifier having at least one transistor, according to claim 2, wherein temperature control algorithm causes the processor to be responsive to the presence of RF signals in the power amplifier to delay the sensing of the operating temperature until after the RF signal slot has passed.

6. A transceiver for a radio telephone for sending and receiving radio signals within a communication network, said transceiver comprising:
a power amplifier connected as part of said transceiver for amplifying said radio signals for transmission, said amplifier having at least one component with a transistor;
a bias supply circuit connected to the power amplifier for supplying a bias current to said power amplifier;
a monitor connected to the power amplifier at the input of the bias supply circuit for sensing a voltage indicative of the voltage drop across said transistor; and
a processor for generating a signal indicative of the operating temperature of said power amplifier in response to the sensed voltage.

7. A transceiver for a radio telephone for sending and receiving radio signals within a communication network, said transceiver, according to claim 6, wherein a temperature control algorithm causes said processor to adjust the operation of said radio telephone in response to said operating temperature signal.

8. A transceiver for a radio telephone for sending and receiving radio signals within a communication network, said transceiver, according to claim 7, wherein the temperature control algorithm causes the processor to shut off the radio telephone when the operating temperature signal exceeds a predetermined value.

9. A transceiver for a radio telephone for sending and receiving radio signals within a communication network, said transceiver, according to claim 7, wherein the temperature control algorithm causes the processor to adjust the bias control supply to the power amplifier in response to said operating temperature signal.

10. A transceiver for a radio telephone for sending and receiving radio signals within a communication network, said transceiver, according to claim 7, wherein temperature control algorithm causes the processor to be responsive to the presence of RF signals in the power amplifier to delay the sensing of the operating temperature until after the RF signal slot has passed.

11. In a radio telephone having a transceiver for sending and receiving radio signals within a communication network and a power amplifier connected as part of said transceiver for amplifying said radio signals for transmission, said amplifier having at least one component with a transistor, a method of obtaining the operating temperature of the power amplifier comprising the steps of:
supplying a bias current to said power amplifier;
sensing a voltage at the bias current supply input to said power amplifier, indicative of the voltage drop across said transistor;
generating a signal indicative of the operating temperature of said power amplifier in response to the sensed voltage.

12. In a radio telephone having a transceiver for sending and receiving radio signals within a communication network and a power amplifier connected as part of said transceiver for amplifying said radio signals for transmission, said amplifier having at least one component with a transistor, a method of obtaining the operating temperature of the power amplifier, according to claim 11, further comprising the step of adjusting the operation of said radio telephone in response to said operating temperature signal according to a predetermined algorithm.

13. In a radio telephone having a transceiver for sending and receiving radio signals within a communication network and a power amplifier connected as part of said transceiver for amplifying said radio signals for transmission, said amplifier having at least one component with a transistor, a method of obtaining the operating temperature of the power amplifier, according to claim 12, wherein said adjustment step comprises shutting off the radio telephone when the operating temperature signal exceeds a predetermined value.

14. In a radio telephone having a transceiver for sending and receiving radio signals within a communication network and a power amplifier connected as part of said transceiver for amplifying said radio signals for transmission, said amplifier having at least one component with a transistor, a method of obtaining the operating temperature of the power amplifier, according to claim 12, wherein said adjustment step comprises adjusting the supply of bias current to the power amplifier in response to said operating temperature signal.

15. In a radio telephone having a transceiver for sending and receiving radio signals within a communication network and a power amplifier connected as part of said transceiver for amplifying said radio signals for transmission, said amplifier having at least one component with a transistor, a method of obtaining the operating temperature of the power amplifier, according to claim 12, further comprising the step of sequencing said sensing of voltage in response to the presence of RF signals in the power amplifier and delaying said sensing of said voltage until said RF signals have passed.
